(19) United States
(12) Patent Application Publication
(10) Pub. No.: US 2005/0086102 A1
(43) Pub. Date: Apr. 21, 2005

(54) Method and system for validation of service consumers

(75) Inventors: Colin G. Harrison, Brookfield, CT (US); John Morar, Mahopac, NY (US); Edith H. Stern, Yorktown Heights, NY (US); Barry E. Willner, Briarcliff Manor, NY (US)

Correspondence Address: Eric W. Petraske, 68 Old Hawleyville Road, Bethel, CT, 06801, US

(73) Assignee: INTERNATIONAL BUSINESS MACHINES CORPORATION, Armonk, NY (US)

(21) Appl. No.: 10/685,612

(22) Filed: Oct. 15, 2003

(51) Int. Cl. G06F 17/60

(52) U.S. Cl. 705/14; 705/1

(57) ABSTRACT

A service Provider tests and validates the ability of a customer to carry out its part of the service process, to specify parameters of the process and/or to use the output of the process supplied to it by supplying to the Consumer a set of first validation data that is processed by the Consumer to produce a second set of validation data that is compared with a set of criteria and a process specification to determine if the Consumer has successfully processed the first set of validation data.

### FIELD OF THE INVENTION

The field of the invention is that of providing services in distributed computing and internetworked environment, in particular a system and method for service Providers to validate or qualify the ability of service Consumers to properly use their services.

### BACKGROUND OF THE INVENTION

This invention concerns the technical problems associated with connecting computer programs together so that, for example, one program can request a service from a second program and the second program can effectively respond and provide that service. Specifically this invention concerns the problem of how the program providing the service—hereafter the Provider—can be sure that the program invoking the service—hereafter the Consumer—knows how to use the service correctly so as to obtain the desired result.

Connecting Computer Programs Together

The problem of connecting computer programs together as envisaged here has long been known to present severe technical difficulties. Many methods have been invented to produce such connections. One of the earliest approaches is still known today as “screen scraping” in which the Consumer program emulates a computer terminal that would normally provide the input and output channels for the Provider program. During the 1980s the Remote Program Call (RPC) method emerged in which the Consumer program uses a dedicated network function to pass messages between the Consumer and Provider programs. In the late 1980s and 1990s object oriented programming methodology introduced the ideas of an interface definition, specifying how a given object can be bound into the main program, a distributed object framework that can relay messages to remote objects, and an object resource broker that can find objects that exactly match a required interface specification (e.g. CORBA, RMI). A trend along this path is towards later and more flexible binding. For example, the screen scraping method and the RPC method depend on code bindings that are produced at compile time and are also brittle, meaning that even minor changes in the operations of the Consumer or Provider will cause the methods to fail. The object-oriented approaches support run-time binding mechanisms, but are also brittle in that they require exact matches of the interface specifications.

For these reasons of early binding and brittleness, the Consumer-Provider model of distributed computing has been difficult to implement. Where it has been used, for example, in Enterprise Resource Planning (ERP) systems, it has tended to be based on proprietary interface specifications and to rely on detailed interface design and testing to ensure correct operation of the Consumer-Provider relationship. Such systems are hard and expensive to develop and to modify and consequently have been limited in their deployment to large enterprises. They are also inherently closed because of the proprietary nature of the protocol details. On the other hand the Worldwide Web, which depends on a single, publicly-specified interface protocol (HTTP) built on top of the public Internet Protocol has demonstrated the value of flexible, dynamic access to millions of Providers and consequently hundreds of millions of instances of the connection of a Web browser (Consumer) to a Web server (Provider) exist and are established and canceled at the click of a button. The ability to establish and cancel connections between Consumer and Provider programs with the same ease as surfing the Web is a highly sought-after goal.

Computer Programs as Business Processes

The advent of e-business during the 1990s introduced the model of an enterprise as a collection of business processes. Each business process has a Provider interface into which Consumers submit requests for services—for example by completing a paper form—and a Consumer interface which receives the service or notification of the dispatch of the service—for example a shipping document. These business processes are increasingly implemented or shadowed as computer applications. Much of the work involved in implementing e-business has been in integrating these applications together to form business process networks. The idea of modeling an enterprise as a network of business processes has been extended to the interconnection of enterprises and this lead to the idea of providing a flexible, dynamic binding method to enable an enterprise to buy services from a Provider and to change that service Provider at will. This idea evolved into Web Services and subsequently evolved backwards into a general method of Enterprise Application Integration. A community of software developers, lead by Ariba, IBM, and Microsoft has developed a set of open industry standards for the processes of discovering service Providers that meet a set of functional requirements, with provision for fuzzy matching, for dialog between a Consumer and Provider on the methods of interaction, and a business transaction method that ensures payment for services delivered. While Web Services are one of the main application areas for this invention, the invention is not limited in any way to being implemented only through the Web Services standards and could be implemented through other public or proprietary interface methods.

Service Oriented Architectures (SOAs)

Today's typical enterprise depends on distributed systems linked via networks to perform many if not most routine computing tasks. For instance, when the typical bank creates a new account, entries may be created in a variety of distinct databases. In particular, one database may hold the customer identification number and tax information, another database may hold the customer mailing information and another database may hold account balance information. Furthermore, many other applications usually employ these same databases and have their own access methods and means for updating information. In spite of numerous industry efforts to reign in the complexity of such systems, this approach has led to systems that are expensive to maintain and tend to be fragile. Perhaps the most undesirable characteristic is that small (seemingly harmless) changes in any one of the distributed systems may lead to unexpected and unpredictable consequences for applications that had unknown dependencies on the part that was modified. Indeed, any change to operating systems requires careful research into known dependencies followed by expensive change planning followed by a through and broad system testing.

A concept referred to as service oriented architecture (SOA) is currently popular within the computing industry as a way to reduce the cost of designing, creating and managing such distributed systems. The fundamental idea is to divide the computing tasks into discrete blocks that can be addressed individually, and then later combined into higher level functional blocks. The ability to isolate the function in discrete units which can each be designed, evaluated and constructed separately promises to reduce the complexity of the overall system, especially at the point in time where a system needs to be fixed, modified or extended. The current technology of choice for implementing a services oriented architecture is to represent each of these blocks of function as a web service.

Web Services

Web services are a loose collection of specifications currently being standardized across the IT industry. In this technology, the blocks of function are referred to as web services. The web service specifications address how the blocks communicate and provide a means of describing the web service interface using Web Services Description Language (WSDL). WSDL is an eXtensible Markup Language (XML) based language for describing the services invocation syntax, error syntax and security along with many other characteristics such as quality of service. The web services collection of specifications are intended to go beyond basic connection to cover transactional interactions, reliable delivery, and a method according to which multiple web services can be combined or composed into yet new web services with their own WSDL description.

The most basic pattern of usage of a web service is for a service Consumer to request services from a service Provider. Information necessary to formulate the service request call is contained in the WSDL document associated with the service being called. The goal of the authors of these WSDL documents is that a Consumer that follows the specification will receive the correct response. There are many ways a client may discover the availability of a service and multiple ways the client may obtain the specific calling information recorded in the WSDL document.

The two typical styles of interactions employed by web services are Remote Procedure Call (RPC) based and asynchronous or Document Literal (DocLit). In RPC style, the calling system invokes a function with optional parameters on the serving system. The serving system performs the function and returns results or an error to the calling system. At that point, the RPC call has completed. The DocLit style is somewhat different conceptually in that the relationship between service Consumer and service Provider is somewhat different. A DocLit interaction is initiated through a web services call that transfers a document (an information container) to the service Provider. The service Provider performs processing based on the document's origin, type or content and then makes a subsequent web services call transferring a responsive document containing the desired information to a web service Provider associated with the initiating node, or with some other node. This is sometimes referred to as document passing style. One skilled in the art will immediately recognize that any set of function implemented in DocLit style may be reproduced with an RPC implementation and vice versa. Of course, the overall system characteristics such as race conditions and performance can be quite different in the two styles.

The web services specification materials describe a repository that can be used to store web services, their WSDL description and other identifying information that can be used to locate, select and ultimately use a particular supplier of a web service.

One familiar with the history of distributed computing will recognize many similarities between web services and earlier technologies such as Common Object Request Broker Architecture (CORBA) where Interface Definition Language (IDL) plays a role similar to WSDL for web services. CORBA is currently used in the industry, but has not achieved the level of adoption necessary to converge the IT industry on a universally accepted interface technology.

Authentication of a user: Many computer programs require the end-user or a program representing the end-user to prove the identity of the user prior to allowing the user access to the program's capabilities. The simplest method of this is a logon based on a userid and secret password. Other methods include providing a certificate of identity generated by a third party and challenges based on shared secret knowledge or in possession of a computing device that is (approximately) synchronized with the computer issuing the challenge and which can generate a response using an algorithm that depends on the time of day or a combination of the time of day and the challenge. The proof of identity is a necessary element of secure computing and will often be a necessary function in establishing a relationship between a Consumer and a Provider, but it does not by itself validate that the user or programs representing the user can effectively engage with a Provider; i.e. that the Customer is capable of sending a correct transmission to the Provider.

Certification of network equipment, including computer programs: Since the advent of telephone networks, network operators have required that, prior to equipment being connected to the network, it must have been proven that the equipment does not present any danger or threat to the network and that the equipment correctly implements the network protocols. More recently this requirement has been extended to functionality that is implemented through software. This proof is produced by off-line exercising of the equipment or software against certified test equipment and software that simulates the behavior of the real network. These tests are generally conducted once when a new product is ready for service and are not repeated during the lifetime of that version of the equipment. Moreover, if the equipment is produced in volume, the testing is applied only to a small number of units. The design is then homologated. This procedure is performed off-line and only once.

Verification of input accuracy: For complex or critical requests from a Consumer of services, for example financial transfer services between banks, it is desirable to verify that the Consumer has specified a valid request. For example, in a financial transfer system a Test function may exist in which the source and destination accounts, the currency and amount to be transferred, and the effective date of the transfer are entered together with a Test encryption key. This Test request is transmitted to the destination bank, which recognizes from the key that it is a test. The destination bank verifies that the accounts, currency, and effective date are valid, and if all is correct, notifies the Consumer that such a request, if submitted with a real key would be accepted for processing. Such a validation method proves the ability of the Consumer to correctly specify a simple request in which the parameters are essentially independent and knowably correct values.

Ordering merchandise from an on-line store is similar, in that the customer clicks on the displayed stock number and enters a credit card number, which has a specified number of digits and a checksum. The vendor checks that the number of digits is correct and verifies the checksum value.

However in the kinds of transactions envisaged for Web Services, complex dependencies exist among the parameters. As a trivial example, when making a request for nuts and bolts it will often be the case that the quantities of each will be the same. In a more complex case, the request may concern a large Bill of Materials with similar trivial dependencies among the individual parts but with the option for the Provider to substitute after-market parts for OEM parts. Here the ability of the Consumer to generate a correct input and to process the response from the Provider are qualitatively different from simple verification of input accuracy.

Verification of operator capability: For reasons of safety, vehicles and heavy equipment may require the operator to perform a certain task before he or she is allowed to start operations. This verification is intended to prove that the operator is physically and mentally capable of performing the operations needed to safely operate the vehicle or equipment. In particular it is intended to detect whether the operator is tired or under the influence of alcohol or other drugs. Typically such tasks require some mental/physical coordination in the form of a kind of game or some mental capacity to perform a calculation or logical problem. While such verification can determine whether the operator is generally mentally and physically capable of performing the kinds of tasks needed to operate the equipment, it does not verify that the operator can in practice operate the equipment. A computer analogy might be to provide a verification method that allowed a Provider to access the system management status of the computer on which the Consumer program is running. This could determine that the computer itself is operating, but it is not sufficient to confirm that the Consumer can in fact correctly operate with the Provider.

Service Level Agreement (SLA)

A service level agreement or SLA is a means for specifying and quantifying the level of service offered by a service Provider. Indeed, a service level agreement could be a written document or an electronically readable specification for various characteristics of the service. For instance, a service level agreement may specify the level of availability of a service such as available at least 99.95% of the time. Another example of a service level agreement component would be a response time specification such as—response will be provided to every query within 5 seconds at least 98% of the time during which the service is up. Service level agreements can be very complex and can even place requirements on the Consumer of the service. Service level agreements are limited in that they only assert capabilities, and may go on to describing an executable procedure for measuring compliance based on mutually accepted primitive definitions and concepts.

In order for service Providers to more easily conform to SLA agreements, methods of monitoring systems to ensure performance have been developed. U.S. Pat. No. 5,893,905, entitled “Automated SLA performance analysis monitor with impact alerts on downstream” teaches a system and method for monitoring the performance of selected data processing jobs, comparing actual performance against the Service Level Agreement (SLA) to which each monitored job belongs, identifying discrepancies, and analyzing impacts to other jobs in a job stream. This allows more effective compliance with SLA terms.

### PROBLEMS WITH THE PRIOR ART

Test methods today allow users to verify the function of the service Provider. What is needed is a method for services to validate that Consumers have the ability to properly use the service. Further, what is needed is the ability to validate this ability at any time, especially when changes in hardware and software make it more likely that problems may occur.

RPC and object oriented technologies require prior agreement as to implementation techniques; these are tight couplings. What is needed is loose bindings to allow ad hoc service usage and application integration

SLAs cover the service Provider commitments but do not require any compliance by the Consumer of the service. Some services require appropriate use; further some services may be more economically supplied to those subscribers who are able to appropriately take related actions such as problem determination, and reporting.

The reliability, viability and effectiveness of a service Provider can depend on how the service is used by the Consumers of the service. There are many causes for service failure that derive from improper usage of the service rather than from a failure within the service. Additionally, a service Provider may make changes which affect the behavior of the service, causing failure. What is needed is a way for Providers to validate the ability of a user to use the service.

### SUMMARY OF THE INVENTION

The invention relates to a method, apparatus and system by which a computerized service Provider can require the service Consumer to test and confirm, or validate, their ability to correctly use the service.

A feature of the invention is the receipt of test data by the Consumer that the Consumer operates on to generate a Consumer output that is validated by the Provider.

Another feature of the invention is a response by the Provider to the Consumer indicating the result of the assessment by the Provider; e.g. pass/fail.

Yet another feature of the invention is a response by the Provider to the Consumer indicating a contingent result of the assessment by the Provider; e.g. permission to place service requests for a period of time.

Yet another feature of the invention is the supply by the Provider to the Consumer of test data to be used in generating the Consumer's output.

Yet another feature of the invention is a linking by the service to other services that it uses, so that the validations can be “chained” to allow validation end to end.

### BRIEF DESCRIPTION OF THE FIGURES

The foregoing and other objects, aspects, and advantages will be better understood from the following non limiting detailed description of preferred embodiments of the invention with reference to the drawings that include the following:

FIG. 1: WSDL service invocation

FIG. 2: Service Oriented Architecture

FIG. 3: Call flow of the inventive method

FIG. 4: Flowchart of elements of the method for a service Provider

FIG. 5: Flowchart of the elements of the method for a service Consumer

FIG. 6; Multiple chained service Providers

FIG. 7: Call flow of the inventive method, with complex validation

FIG. 8: Business models supported by the invention

### DETAILED DESCRIPTION OF THE INVENTION

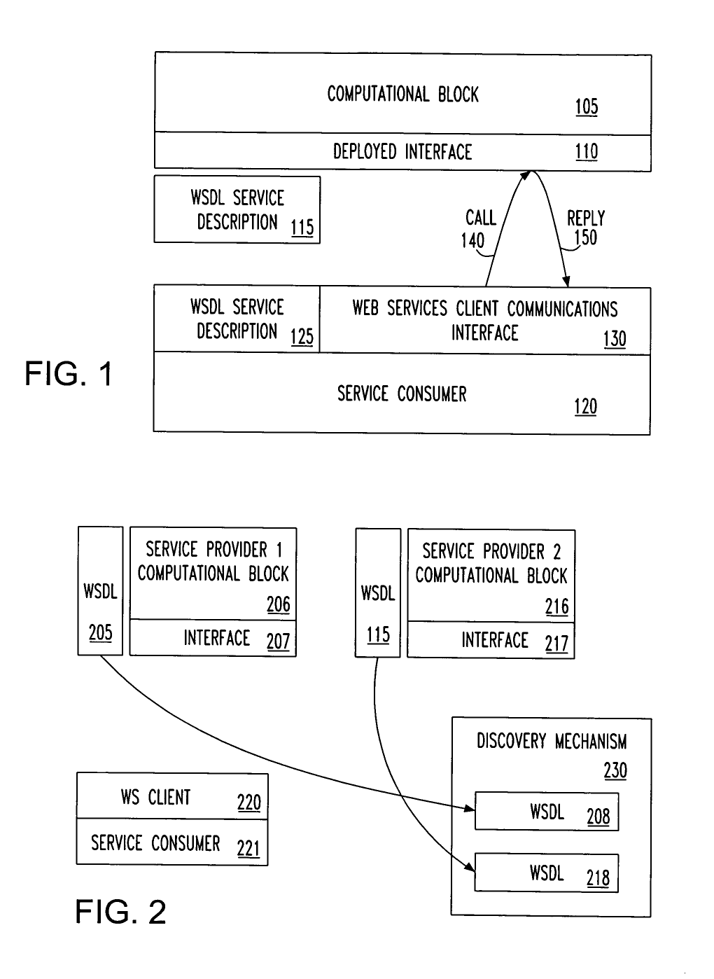

FIG. 1 illustrates a common method for using the web services specifications for interaction between a service Consumer and a service Provider. A computational block (105) is to be made available as a web service. This is accomplished by deploying a web service interface (110) and making a WSDL description of the interface (115) available to potential service Consumers. At this point, the web service is said to have been deployed.

Through a variety of potential methods (one of which will be described below) the service Consumer (120) obtains a copy (125) of the WSDL document (115) and uses it to configure the web services client (130) with information about the service call format and the service location. This example describes the RPC style of interaction. Once the client is configured, a call originating within the service Consumer (120) will be processed by the web services client stack (130) which will format the information and direct the call to the web services Provider interface (110). The web services Provider interface (110) will receive the information, convert it to a suitable format and then launch the indicated function within the computational block (105). Once the computation has completed the result (or error information) will be appropriately packaged and returned by the deployed interface (110) to the web services client (130) which will perform any necessary unpacking of the information and provide it to the service Consumer (120), thereby completing the RPC invocation.

FIG. 2 illustrates the described characteristics of a services oriented architecture. Not all of the elements described here are necessary for an implementation to qualify as a services oriented architecture. In particular, there are a variety of discovery mechanisms that could be employed, including an out-of-band process that provides appropriate information about services to the client implementation or programmer.

Service Provider 1 deploys his service consisting of a WSDL description (205) computational block (206) and interface 207 as illustrated in FIG. 1. Then Service Provider 1 or his agent publishes a WSDL description for service interface 207 (possibly with other descriptive information) in a discovery mechanism (230) which will frequently be built to the Universal Description, Discovery and Integration (UDDI) specification. Subsequently, Service Provider 2 deploys his service consisting of a WSDL description (215) computational block (216) and interface 217 as illustrated in FIG. 1. Then Service Provider 2 or his agent publishes a WSDL description for service interface 217 (possibly with other descriptive information) in discovery mechanism (230).

When service Consumer (221) decides to use a service it can search the discovery mechanism (230) for a service with the desired characteristics, then use the stored WSDL (either 208 or 218 depending on the service chosen) to configure the communications interface (220) (as illustrated in FIG. 1) for requesting service from the chosen service. One of the manifest advantages of a properly designed and implemented service oriented architecture is that an equivalent service can be substituted for a currently used service with little change to anything but the communications interface, and that change should be limited to configuring or modifying the interface to use the information found in the appropriate WSDL document.

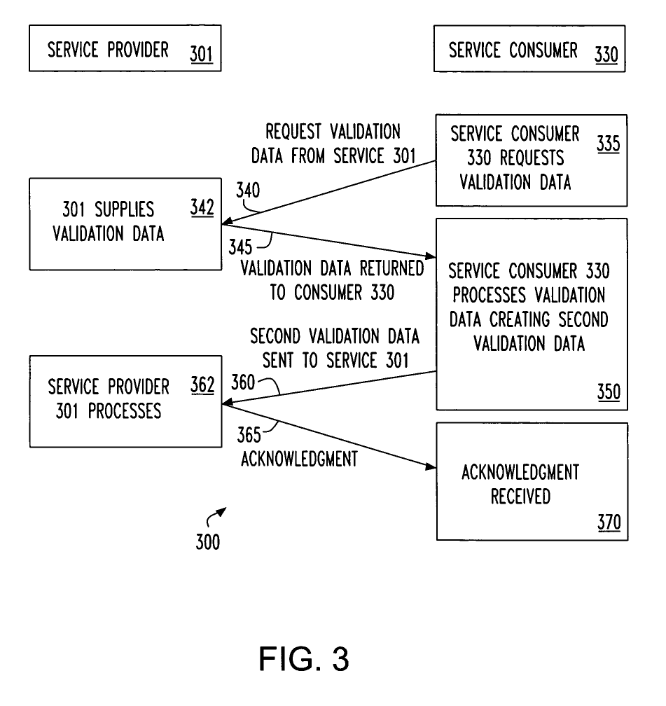

FIG. 3 shows a block diagram illustrating the call flow, denoted generally by the numeral 300, of the inventive method. After service Provider (301) has deployed one or more web service interface(s) that can process data and provide validation data, and after service Consumer 330 has created a service client that is configured to interact with Provider (301) then the illustrative call flow shown in the bottom half of FIG. 3 can begin. (Note: the two functions of providing validation data and consuming second validation data could be combined into a single web service that, through appropriate semantic and/or syntactical means, can distinguish between the two functions. Alternatively, the two functions could be provided as separate web services.) The flow is initiated in step (335) in which service Consumer 330 requests the first validation data (indicated by arrow 340) from service Provider 301. In step 342, service Provider (301) generates or retrieves the first validation data. In step 345, the first validation data is transmitted to the service Consumer (330). Though FIG. 3 (300) illustrates this interaction in the form of an RPC style web services interaction, this illustrative sequence could be realized by the equivalent set of Doc-Lit asynchronous messages.

In step 350, the service Consumer (330) receives the first validation data and operates on or performs whatever processing the Consumer is constructed to perform. The result of this processing is herein referred to as the second validation data.

The first validation data may be chosen with great flexibility. For example, they may include a catalog or price list of offerings by the Provider. They may also include a small amount of data chosen to make the process easy for the Consumer, or anything in between. The first validation data may include one or more of random numbers, reserved invariant data, reserved variant data, invalid data (e.g. nonexistent part numbers intended to validate error processing), data indicative of processing to be performed for validation response and others.

The process of making the first validation data available to the Consumer may include many methods such as publishing first validation data to the web, making data available for download, transmitting a pointer to data, providing a removable media, creating one time valid first validation data and creating personalized first validation data.

An example of the intended service is a parts ordering service (e.g. of a hardware store to a hardware distributor); the first validation data may contain hardware item numbers. The Consumer is expected to construct from this first validation data a sample order of parts from each category available. The constructed order may be the second validation data. This is very different from current e-business methods such as on-line ordering from a vendor such as Amazon. In today's ordering methods, an order is placed and the validation of the order or credit card may consist of checking that the catalog numbers are ones that appear in the catalog and that the credit card number is valid. Such a process does not allow the Provider to evaluate the user's ability to filly use the service (e.g. register reviews).

Referring back to FIG. 3, in step (360) the second validation data is transmitted to the service Provider (301). In step (362) the service Provider processes the second validation data and in step 365 (optionally) acknowledges the completion of the processing. Once again, the final web service interaction is represented as an RPC interaction, and could equally be achieved by one or more asynchronous Doc-Lit style interactions. Indeed, in the Doc-Lit interaction, the acknowledgement (step 365) could be directed to a different entity from the service Consumer (330).

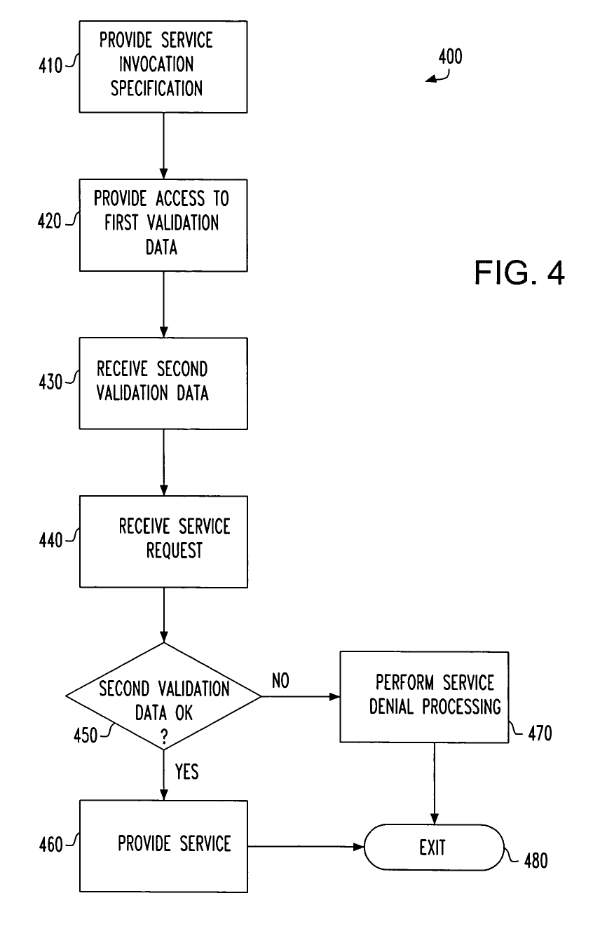

FIG. 4 shows a flowchart of the elements of the inventive method, denoted generally by numeral 400, that are performed by a service Provider. In step 410, the service Provider makes available an service invocation specification. In one embodiment, the specification is made available through a web services interface. In this case, the service Provider may be registered via a Universal Description, Discovery and Integration (UDDI) directory, and use WSDL to provide the service specification. Details on UDDI are available at http://www.uddi.org/specification.html. The service invocation specification provides enabling detail on how to access the service. In other embodiments, the specification may be made available through a web page, as machine readable material on a removable media such as a diskette, CD-ROM, DVD or zip disk, published in a journal, or any other convenient method. The invocation may be available generally, or may be available to a subset of the general public or any collection of one or more potential service Consumers.

In general, the specification may include criteria that the Provider requires to be met before providing service. The criteria according to the invention may be very flexible. For example, one or more answers or elements of the second validation data may be required to be correct. One answer may be required to be correct, with incorrect answers on other points resulting in a different level of service and/or different cost, rather than denial of service. The answers or responses may be within a range of acceptability rather than according to a binary True/False approach.

As one example, the Provider may (temporarily) accept all responses to the first validation data, i.e. effectively suspending the validation process, in order to increase business or for other reasons.

We continue to step 420. In this step, the service Provider provides access to first validation data. Access may be provided by any of: publishing first validation data to the web, making data available for download, transmitting a pointer to data, providing a removable media, creating one time valid first validation data and creating personalized first validation data.

This data is provided along with the invocation specification of step 410 so that a service Consumer may exercise the service Consumer's process on the validation data, in a manner consistent with the service invocation specification. The data provided may be the same for all service Consumers, e.g. generally available, or may be specific to the service Consumer, e.g. available upon request and customized. In step 430, the service Provider receives second validation data from a service Consumer, such data expected to be responsive to the validation data and invocation specification of steps 410 and step 420. This second validation data is used by the service Provider to evaluate the capability of the service Consumer to properly consume the service. The service Provider may optionally acknowledge the receipt of the second validation data.

This may be understood from the following two examples:

A service Provider HD is a hardware parts distributor, and receives parts from a multitude of suppliers. The catalogue of parts from HD is therefore somewhat variable. HD wishes to minimize the disruption of receiving invalid part numbers on orders from HD's customers, these customers being local hardware retail stores. In order to receive some assurance that the local hardware retail stores can formulate a good order, HD publishes a web service for such orders, including a validation service (step 410). The validation service makes available a validation data catalogue with bogus part numbers to prospective hardware store customers. The hardware store customers must use the validation data catalogue, provide an order in accordance with the invocation specification, and send the order to the hardware distributor HD (received in step 430). If the order is well formulated with appropriate volumes, contents, shipping, etc., then HD will allow service to be provided. Note that many possible orders can be constructed from the catalogue. In this example, there is no specific order required—simply a valid order must be constructed by the service Consumer, and appropriately transmitted to the service Provider.

A second example concerns a network service. A network service Provider may provide a multi-network spanning multi-modal conferencing service. In order to minimize help desk costs, and maximize availability, this service Provider wishes to ensure that prospective clients are able to assist in problem determination. In this example, the service invocation details are published, along with trouble report ticket specifications (step 410). On service Consumer request, network services with errors injected are provided to the service Consumer (e.g. validation data per step 420). The service Consumer must construct appropriate trouble reports and send them to the service Provider (received in step 430). In this fashion, the service Provider can reduce the risk of improper error reporting in regards to the service, and presumably keep costs of problem determination and repair at a minimum.

We continue with step 440 of the method. In this step, the service Provider receives an actual request for service from a service Consumer. In step 450, the service Provider determines whether the validation data received from the service Consumer in step 430 are acceptable. If so, the service is provided in step 460. If not, the Provider executes step 470. In either case, the process ends at step 480. Note that this step 450 may be performed before step 440 rather than afterwards. Optionally, the results of this determination may be transmitted to the service Consumer.

In some embodiments, second validation data which had been acceptable at one point in time, may not be acceptable at a later time. Time since receipt of second validation data, software or hardware update status, calendar date, method of access, scope of service requested, or other criteria may be used to determine whether the second validation data received from the service Consumer is acceptable.

If the data is acceptable, we continue to step 460, and provide the requested service. Note that additional processing may occur before service is provided. In some embodiments, the service Provider may require interaction with the Consumer, may require interaction with a credit bureau to check service Consumer credit rating, etc. Following step 460, the method may optionally loop back to step 440, and the service Provider may receive another service request. Alternately, the method ends with step 480 as we exit.

If step 450 determines that the second validation data is not acceptable, we continue to step 470 and perform service denial processing. This processing may include but is not limited to transmitting an indication of refusal of service, transmitting an indication of requirement of new second validation data, publishing a notice of service refusal, transmitting an indication of refusal to a third party, transmitting an indication of requirement of new second validation data to a third party. Optionally, the method continues from this step to step 410, or step 420, or step 430. Otherwise, we end the method at step 480 and exit.

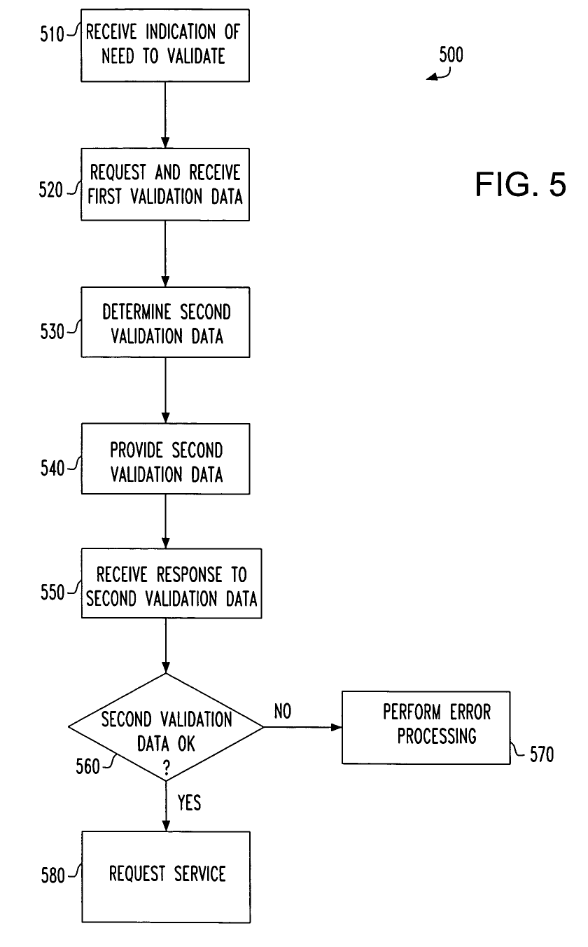

FIG. 5 shows a preferred embodiment of the method for a service Consumer. The method, denoted generally with the numeral 500, begins with step 510, where the service Consumer receives an indication from the service Provider of a need to validate the service Consumer's ability to properly consume the service before service is provided. Prior to this step, the service Consumer may have recently requested service (i.e. the indication of a need to validate may be in response to a request for service). Alternately, the service Provider may send such an indication periodically, or upon change to the invocation specification, or upon change to some other aspect of the service. If the indication was not in response to a request for service, then presumably the service Provider has had a business relationship of some sort with the Consumer thereby enabling the Provider to send such an indication.

We continue to step 520. In this step, having received the request to validate, the service Consumer requests first validation data. While we do not show a step of the service Consumer receiving the invocation specification for the service, it is understood that prior to the request for first validation data, the service Consumer may optionally have requested and received the invocation specification. Further in this step, the service Consumer receives said first validation data. The data may be received from the service Provider, or from a third party responsive to the request.

Responsive to the first validation data, and according to the understood service invocation specification, the user service Consumer determines (or generates) second validation data in step 530. That is, the service Consumer applies the service consuming process to the first data and provides second data in accordance with the service. Note that while this method discusses a single step of interaction between the parties, it is understood that there may be multiple steps of interaction required to complete the determination of the second validation data.

We continue in step 540, where the service Consumer provides the second validation data. This data may be provided to the service Provider, or to a third party as indicated by the service invocation specification.

In step 550, the service Consumer receives an optional response from the Provider to the second validation data. This response may be an acknowledgement, or an indication of the validity of the data as received. If no response is expected or received, the user may proceed directly to step 580. Alternatively, if a response is expected but not received, the user may proceed directly to step 570.

In step 560, the service Consumer evaluates whether the second validation data was acceptable as indicated by the response. If the data was acceptable, the service Consumer may continue to request service in step 580. Note that this step may follow 560 with any degree of elapsed time. That is, the service Consumer may rapidly request service, or not. Such a service request may wait for Consumer need, scheduled request, etc.

If the second validation data was not acceptable as indicated by the response, we proceed to step 570, and the service Consumer may perform error processing. This processing may consist of logs, error messages, alerts and notifications, alarms, revalidation attempts, etc.

The method completes after these steps.

The foregoing example illustrates that the invention is not confined to one model of the relationship between the Provider and the Consumer. At one extreme, a powerful Consumer may specify formats and other criteria and require its vendors to conform to that specification as a condition of doing business. At another extreme, a large vendor may require its customers to conform to its method of accepting orders. Yet other relationships may have a mixed model in which both sides specify aspects of the transactions.

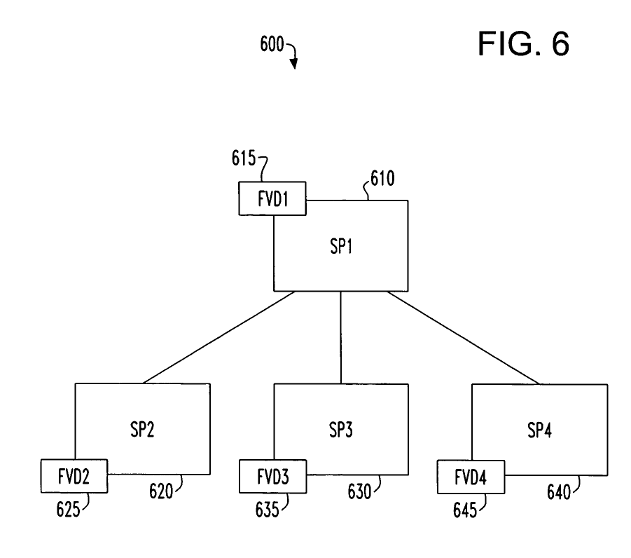

FIG. 6 shows an example of the invention as used in conjunction with multiple service Providers in a relationship, denoted generally with the numeral 600. In this example, a service Consumer (not shown) obtains service provided by a service Provider SP1 noted as block 610, which itself obtains services from other service Providers SP2 (block 620), SP3 (block 630), and SP4 (block 640).

This example may be better understood by reference to a supply chain application. Assume that SP1 of block 610 is a bundler of goods (e.g. a hardware parts distributor) obtaining these goods from SP2 of block 620 (a nails manufacturer), SP3 of block 630 (a screw manufacturer), and SP4 of block 640 (a bolt manufacturer). SP2 makes available an invocation specification (not shown) and first validation data FVD2, block 625. SP3 makes available an invocation specification (not shown) and first validation data FVD3, block 635. SP4 makes available an invocation specification (not shown) and first validation data FVD4, block 645. This information may or may not be made available to the general public, but is made available to service Provider SP1, block 610. In our supply chain example, first validation data FVD2 consists of sample part numbers of nails. First validation data FVD3 consists of sample part numbers of screws. First validation data FVD4 consists of sample part numbers of bolts. The invocation specification details how to construct acceptable orders. Service Provider SP1 of block 610 offers services to a hardware store. SP1 makes available an invocation specification (not shown) and first validation FVD1.

A user of SP1 services (e.g. a local hardware store) requests validation. In response to the request for validation, SP1 requests access to first validation data from SP2, SP3, and SP4. SP1 obtains access to this data, and constructs its own first validation data FVD1. In our example, SP1 receives sample part numbers of screws, bolts and nails, and adds to these a part number for a free apron. The information is further processed (e.g. translated to Spanish). This is used to construct SP1 first validation data, that is FVD1 of block 615. Access to FVD1 is provided to the hardware store requesting service. This first validation data represents a one time collection of items that may be ordered to validate the hardware store's usage of the service.

The user of the service (the hardware store) must then create an order from among these items and return it to SP1 as second validation data to validate that they can indeed create properly structured orders from available parts. SP1 receives the order, examines it to conclude whether or not it is ok, and may optionally confirm back to the user. SP1 may or may not provide second validation data to SP2, SP3, SP4 depending on the structure of their validation process. This validation can be for free or for a fee.

Let us take a second example from this figure. SP2, SP3, SP4 may be gateways to disparate networks, and SP1 a bundler of services from among those networks. The validation may be in exercising a complex network service such as multimodal conferencing among disparate endpoints. Validation may be for the purpose of validating ancillary management such as billing and problem determination.

In order to verify that the user can properly participate in problem management, the validation scenario may be as follows. Following the SP1 invocation specification (not shown), the user requests of SP1 a service validation and provides addresses of participating devices. SP1 then requests first validation data of downstream Providers SP2, SP3 and SP4, providing the relevant addresses of participating devices. SP2 makes available an invocation specification (not shown) and first validation data FVD2, block 625, consisting of errors injected into communications to devices attached to the SP2 network. SP3 makes available an invocation specification (not shown) and first validation data FVD3, block 635, consisting of errors injected into communications to devices attached to the SP3 network. SP4 makes available an invocation specification (not shown) and first validation data FVD4, block 645, consisting of errors injected into communications to devices attached to the SP4 network. SP1 aggregates error indications received in its elements associated with the device addresses, and provides these indications to the service Consumer. In accord with the service invocation (not shown), the service Consumer must create an appropriate problem report as second validation data and provide it to SP1. Presumably complete and accurate creation of such a problem report will allow SP1 to judge that the service Consumer will be a low cost customer to maintain, since they are able to fully participate in problem determination.

While these examples show a service Provider hierarchy that is a single level deep, it is understood by those skilled in the art that the hierarchy may be many levels deep. That is, service Providers discussed may themselves obtain services from other service Providers—SP2 may receive services from SP5 and SP6 (not shown). SP5 may receive services from SP7 (not shown), and so on.

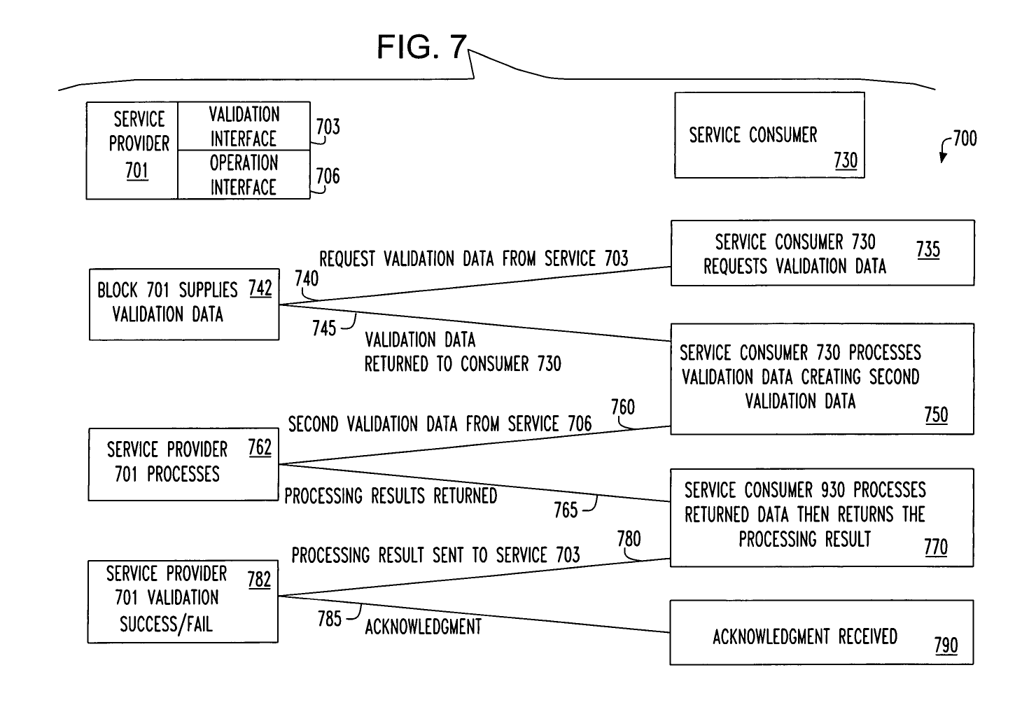

FIG. 7 shows a block diagram illustrating a more complex validation sequence. After service Provider (701) has deployed web service interfaces that provide validation data and process functional data (703 and 706 respectively). And after service Consumer 730 has created a service client that is configured to interact with Provider (701) interfaces, then the illustrative call flow shown in the bottom half of FIG. 7 can begin. (Note: the two functions of providing validation data and consuming second validation data could be combined into a single web service that, through appropriate semantic and or syntactical means, can distinguish between the two functions. Alternatively, the two functions could be provided as separate web services as shown here.) The flow is initiated in step (735) in which service Consumer 730 requests the first validation data (via 740) from service Provider interface (703). In step 742, service Provider (701) generates or retrieves the first validation data and returns the result. In step 745, the first validation data is transmitted to the service Consumer (730). Though FIG. 7 illustrates this interaction in the form of an RPC style web services interaction, this illustrative sequence could be realized by the equivalent set of Doc-Lit asynchronous messages. In step 750, the service Consumer (730) receives the first validation data and performs whatever processing the Consumer is constructed to perform. The result of this processing is herein referred to as the second validation data. In step (760) the second validation data is transmitted to the service Provider (701) via service interface 706. In step (762) the service Provider processes the second validation data and in step 765 returns the processed result. Once again, the final web service interaction is represented as an RPC interaction, and could equally be achieved by one or more asynchronous Doc-Lit style interactions. Note: the processing results (step 765) could be directed to a different entity (i.e. not the initiating service Consumer 730). In step 770 the processed results of the second validation data are further processed through the requesting service (730) normal functional path. In step (780) these results are sent via the validation interface to service Provider (701). Responsive to the returned results, service Provider (701) returns an acknowledgement (785) to the requester (730) (Note, here again the acknowledgement could be directed to a different entity). The acknowledgement may contain information indicative of the outcome of the processing performed in step (782), thereby potentially providing the client implementation an indication of which processing steps to perform subsequently.

Business Models Supported by this Invention

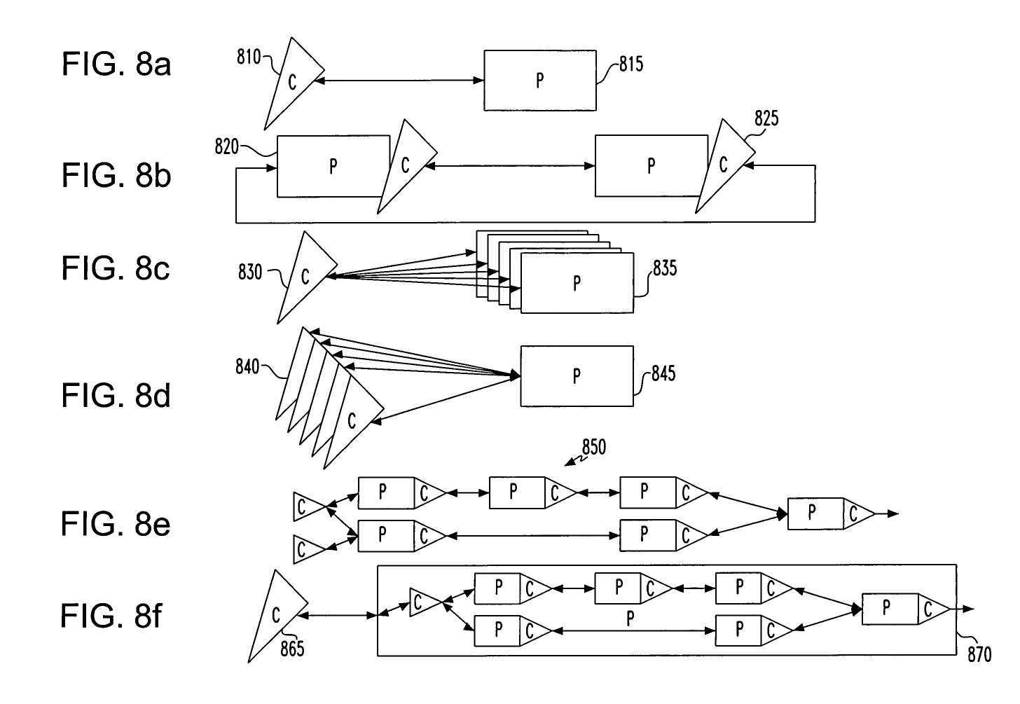

FIG. 8 illustrates the business models supported by this invention.

In this invention the concept of service is quite general. The examples show services that are either a) actions that can be completely executed by computing processes carried out by moving electrons or photons; or b) an action taking place outside electronic apparatus that can be invoked by the execution of computing processes. An example of the first type of action is the translation of a document from one human language to another human language. An example of a the second type of action is the dispatch via a computer action of a 5 ton roll of paper to be cut, packaged, and shipped to meet a customer's specification. A service need not even have an immediate effect on the customer, for example updating a database entry.

The simplest case we consider is a single Consumer 810 connected to a single Provider 815. In many cases a program of the kind we are considering will be both a Consumer 820 and a Provider 825. Its Consumer interface will be connected to the Provider interfaces of one or more other programs and its Provider interface will be connected to the Consumer interfaces of one or more other programs. It is even conceivable that two such programs can be connected on both their Consumer and Provider interfaces.

An important benefit of Web Services is the ability of a Consumer of service to connect simultaneously to one or more Providers of services. The Consumer 830 may selectively direct different requests to different Providers 835 or may invite all current Providers 835 to compete on a single request. Likewise a Provider of Service 845 may be connected to one or more Consumers of Service 840.

The vision of Web Services is the assembly of networks of business processes, implemented as computer programs, in which there are several or potentially many Consumers 820 and Providers 825 connected together 850. While this invention deals with the validation process between a single Consumer and a single Provider, it can also be applied sequentially over such a network 850 of business processes to provide end-to-end validation.

From the point of view of a Consumer of services, a service Provider presents a single interface. However, it is possible that what appears to be a single, monolithic service is in fact a compound service provided by an encapsulated network of sub-Providers 855. While this invention deals with the validation process between a single Consumer and a single Provider, it can also be applied recursively over such hierarchies of Process, sub-Processes, sub-sub-Processes, and so forth.

Although the invention is illustrated with some selected examples, many other embodiments may be included within its scope.

For example, the first validation data may comprise random numbers, reserved invariant data, reserved variant data, invalid data (e.g. nonexistent part numbers intended to validate error processing), data indicative of processing to be performed for validation response and others.

The second validation data may comprise a checksum, a string of checksums, an array of data types responsive to the validation data, an order for service and others.

The validation service may be provided to the Consumer without charge. Alternatively, the Provider may charge for validation after an initial threshold amount—i.e. extra validation services would be billed to the Consumer. The Provider may use the results of a validation in other ways than simply granting on denying service. For example, the Provider may charge extra for providing service if the validation indicates that it will cost more to service this Consumer. As a variation, the Provider may charge a standard rate for one of a family of services for which the Consumer has qualified and extra for other services for which the Consumer has not qualified.

The notice sent to a successful Consumer by a vendor may include a limited time period for which access to services is permitted, a scheduled time for reconfirmation, a subset of services that are permitted, one of multiple permission status (e.g. revalidate on demand, revalidate on Tuesday), etc.

The step of distributing the data or criteria to which the Consumer must conform may include publishing a web service specification, making available a specification for download, making available a machine readable specification for download, transmitting a pointer to a specification, providing a removable medium (e.g. CD ROM) of a specification and others.

The step of providing access to first validation data may include publishing first validation data to the web, making data available for download, transmitting a pointer to data, providing a removable medium, creating one time valid first validation data, creating personalized first validation data and others.

Variations described for the present invention can be realized in any combination desirable for each particular application. Thus particular limitations, and/or embodiment enhancements described herein, which may have particular advantages to a particular application need not be used for all applications. Also, not all limitations need be implemented in methods, systems and/or apparatus including one or more concepts of the present invention.

The present invention can be realized in hardware, software, or a combination of hardware and software. There may be some elements of the inventive system located in equipment controlled by the Provider and other elements located in equipment controlled by the Consumer. The separate elements may be supplied by different vendors (provided they are compatible). An embodiment of the present invention can be realized in a centralized fashion in one computer system, or in a distributed fashion where different elements are spread across several interconnected computer systems. Any kind of computer system—or other apparatus adapted for carrying out the methods and/or functions described herein—is suitable. A typical combination of hardware and software could be a general purpose computer system with a computer program that, when being loaded and executed, controls the computer system such that it carries out the methods described herein. The present invention can also be embedded in a computer program product, which comprises all the features enabling the implementation of the methods described herein, and which—when loaded in a computer system—is able to carry out these methods.

Computer program means or computer program in the present context include any expression, in any language, code or notation, of a set of instructions intended to cause a system having an information processing capability to perform a particular function either directly or after conversion to another language, code or notation, and/or reproduction in a different material form.

Thus the invention includes an article of manufacture which comprises a computer usable medium having computer readable program code means embodied therein for causing a function described above. The computer readable program code means in the article of manufacture comprises computer readable program code means for causing a computer to effect the steps of a method of this invention. Similarly, the present invention may be implemented as a computer program product comprising a computer usable medium having computer readable program code means embodied therein for causing a function described above. The computer readable program code means in the computer program product comprising computer readable program code means for causing a computer to effect one or more functions of this invention. Furthermore, the present invention may be implemented as a program storage device readable by machine, tangibly embodying a program of instructions executable by the machine to perform method steps for causing one or more functions of this invention.

An evaluation according to the invention may be done before initial use of the service, periodically to confirm continued use of the service and/or upon recognition of changes made within the service. If the service itself uses other services, the validations can be “chained” to allow validation end to end. This invention does not require that the Consumer has the ability to test the Provider service. Such testing by the Consumer may or may not be provided in a system employing the invention.

Use of this invention can therefore reduce problems experienced in operational use, can assist in problem determination, can reduce risk for future operation, can provide a means for the service Provider to provide a representation of its clients ability to correctly use the service (e.g. to a third party for certification, for insurance purposes, etc.)

It is noted that the foregoing has outlined some of the more pertinent objects and embodiments of the present invention. This invention may be used for many applications. Thus, although the description is made for particular arrangements and methods, the intent and concept of the invention is suitable and applicable to other arrangements and applications. It will be clear to those skilled in the art that modifications to the disclosed embodiments can be effected without departing from the spirit and scope of the invention. The described embodiments ought to be construed to be merely illustrative of some of the more prominent features and applications of the invention. Other beneficial results can be realized by applying the disclosed invention in a different manner or modifying the invention in ways known to those familiar with the art.

While the invention has been described in terms of selected embodiments, those skilled in the art will recognize that the invention can be practiced in various versions within the spirit and scope of the following claims.

1. A method of validating the ability of a Consumer to carry out a Consumer service process—comprising the steps of:
providing a service invocation specification;
providing to a Consumer first validation data related to a service;
receiving from the Consumer a set of second validation data responsive to said first validation data and complying with said service invocation specification; and
providing the service process responsive to evaluation of said set of second validation data for compliance with said service invocation specification.

2. A method according to claim 1, in which:
said second validation data include data elements that are not included within said first validation data and are generated by said Consumer in response to said first validation data.

3. A method according to claim 1, further comprising:
analyzing compliance by said second validation data with said service invocation specification.

4. A method according to claim 1, in which:
said step of analyzing compliance is performed by a third party that transmits the results thereof to the Provider.

5. A method according to claim 1, in which:
said first validation data include at least one error injected therein; and
said second validation data include an indication of said injected errors.

6. A method according to claim 1, in which:
at least some of said first validation data are generated by a source other than said Provider.

7. A method according to claim 1, in which:
said Provider performs validation without charge.

8. A method according to claim 1, in which:
said Provider charges said Consumer for services at a rate that depends on the result of said validation.

9. A method according to claim 8, in which: said Provider charges at a first rate for services for which the Consumer has qualified and at a second rate for services for which the Consumer has not qualified.

10. A method according to claim 1, in which said Provider validates all second validation data submitted by a Consumer and thereby provides service to all Consumers that submit second validation data.

11. A method according to claim 1, in which:
said Provider performs validation without charge below a service threshold and thereafter charges said Consumer for additional validation services.

12. A method according to claim 8, in which:
said Provider charges said Consumer for services at a rate that reflects an additional cost to said Provider for supplying services to a Consumer that has not met the provisions of said service invocation specification.

13. A method according to claim 1, in which:
the Provider notifies the Consumer that the step of providing the service is contingent on at least one of:
amount of time elapsed since receipt of second validation data remaining below a threshold; reconfirmation after a scheduled time; and
the service will only be provided along with other services.

14. A method according to claim 1, further comprising steps of:
Receiving a Consumer request for first validation data
Responsive to said request, transmitting said first validation data to said service Consumer.

15. A method according to claim 1, in which:
said service invocation specification comprises specifications for a delivered service, which delivered service is supplied in part by at least one third-party Provider that supplies at least one service to said Provider that is included in the delivered service supplied to said Consumer.

16. A method of revalidating the ability of a Consumer to carry out a Consumer service process provided by a Provider comprising the steps of:
providing a service
requesting a Consumer provide second validation data related to the service, and
providing first validation data
receiving from the Consumer a set of second validation data responsive to first validation data
evaluating said second validation data
providing further service responsive to said validation.

17. An article of manufacture comprising a computer usable medium having computer readable program code means embodied therein for causing a validation of a services Consumer, the computer readable program code means in said article of manufacture comprising computer readable program code means for causing a computer to effect the steps of:
providing a service invocation specification;
providing to a Consumer first validation data related to a service;
receiving from the Consumer a set of second validation data responsive to said first validation data and complying with said service invocation specification; and
providing the service process responsive to evaluation of said set of second validation data for compliance with said service invocation specification.

18. An article of manufacture according to claim 17, in which:
said second validation data include data elements that are not included within said first validation data and are generated by said Consumer in response to said first validation data.

19. An article of manufacture according to claim 17, further effecting the step of includes analyzing compliance by said second validation data with said service invocation specification.

20. An article of manufacture according to claim 17, in which:
said step of analyzing compliance is performed by a third party that transmits the results thereof to the Provider.

21. An article of manufacture according to claim 17, in which:
said first validation data include at least one error injected therein; and
said second validation data include an indication of said injected errors.

22. An article of manufacture according to claim 17, in which:
at least some of said first validation data are generated by a source other than said Provider.

23. An article of manufacture according to claim 17, in which:
said Provider performs validation without charge.

24. An article of manufacture according to claim 17, in which:
said Provider charges said Consumer for services at a rate that depends on the result of said validation.

25. An article of manufacture according to claim 24, in which: said Provider charges at a first rate for services for which the Consumer has qualified and at a second rate for services for which the Consumer has not qualified.

26. An article of manufacture according to claim 17, in which said Provider validates all second validation data submitted by a Consumer and thereby provides service to all Consumers that submit second validation data.

27. An article of manufacture according to claim 17, in which:
said Provider performs validation without charge below a service threshold and thereafter charges said Consumer for additional validation services.

28. An article of manufacture according to claim 24, in which:
said Provider charges said Consumer for services at a rate that reflects an additional cost to said Provider for supplying services to a Consumer that has not met the provisions of said service invocation specification.

29. An article of manufacture according to claim 17, in which:
the Provider notifies the Consumer that the step of providing the service is contingent on at least one of:
amount of time elapsed since receipt of second validation data remaining below a threshold;
reconfirmation after a scheduled time; and
the service will only be provided along with other services.

30. An article of manufacture according to claim 17, further comprising steps of:
Receiving a Consumer request for first validation data
Responsive to said request, transmitting said first validation data to said service Consumer.

31. An article of manufacture according to claim 17, in which:
said service invocation specification comprises specifications for a delivered service, which delivered service is supplied in part by at least one third-party Provider that supplies at least one service to said Provider that is included in the delivered service supplied to said Consumer.
